(19) United States
(12) Patent Application Publication
(10) Pub. No.: US 2024/0172092 A1
(43) Pub. Date: May 23, 2024

(54) COMMUNICATION CONTROL METHOD

(71) Applicant: KYOCERA Corporation, Kyoto (JP)

(72) Inventors: Masato FUJISHIRO, Yokohama-shi (JP); Mitsutaka HATA, Yokohama-shi (JP)

(73) Assignee: KYOCERA Corporation, Kyoto (JP)

(21) Appl. No.: 18/430,986

(22) Filed: Feb. 2, 2024

Related U.S. Application Data
(63) Continuation of application No. PCT/JP2022/029640, filed on Aug. 2, 2022.

(30) Foreign Application Priority Data
Aug. 5, 2021 (JP) 2021-128845

(51) Int. Cl. H04W 48/08; H04W 36/00; H04W 74/0833

(52) U.S. Cl. CPC H04W 48/08; H04W 36/0072; H04W 36/00835; H04W 74/0833

(57) ABSTRACT

In a first aspect, a communication control method is used in a mobile communication system including a user equipment and a base station, and being capable of performing wireless communication between the user equipment and the base station. The communication control method includes performing, by the user equipment, a slice-specific random access channel which is a random access procedure using a resource separated per slice or per slice group. The communication control method includes recording, by the user equipment, first log information in a memory, the first log information being acquired when the slice-specific random access channel is performed. The communication control method further includes transmitting, by the user equipment, the first log information to the base station.

### RELATED APPLICATIONS

The present application is a continuation based on PCT Application No. PCT/JP2022/029640, filed on Aug. 2, 2022, which claims the benefit of Japanese Patent Application No. 2021-128845 filed on Aug. 5, 2021. The content of which is incorporated by reference herein in their entirety.

### TECHNICAL FIELD

The present invention relates to a communication control method used in a mobile communication system.

### BACKGROUND OF INVENTION

In the Third Generation Partnership Project (3GPP), which is a standardization project for mobile communication systems, the specifications of network slicing (or network slice) have been drafted.

Network slicing is a concept that allows differentiated processing in accordance with each customer's needs. Network slicing is also a technique for virtually slicing a network so as to efficiently provide a network in accordance with requirements of services used by customers.

### CITATION LIST

### Non-Patent Literature

### Non-Patent Document 1: 3GPP TS 38.300 V 16.6.0 (2021 June)

### SUMMARY

In a first aspect, a communication control method is used in a mobile communication system including a user equipment and a base station, and being capable of performing wireless communication between the user equipment and the base station. The communication control method includes performing, by a user equipment, a random access procedure using a resource associated with a slice group. The communication control method includes recording, by the user equipment, first log information in a memory, the first log information being acquired when the random access procedure is performed. The communication control method further includes transmitting, by the user equipment, the first log information to a base station.

In a second aspect, a communication control method is used in a mobile communication system including a user equipment and a base station, and being capable of performing wireless communication between the user equipment and the base station. The communication control method includes performing, by a user equipment, slice-specific cell reselection using a prioritized frequency mapped per slice group. The communication control method includes recording, by the user equipment, second log information in a memory, the second log information being acquired when the slice-specific cell reselection is performed. The communication control method further includes transmitting, by the user equipment, the second log information to a base station.

### BRIEF DESCRIPTION OF THE DRAWINGS

FIG. 1 is a diagram illustrating a configuration example of a mobile communication system according to an embodiment.

FIG. 2 is a diagram illustrating a configuration example of a user equipment (UE) according to an embodiment.

FIG. 3 is a diagram illustrating a configuration example of a gNB (base station) according to an embodiment.

FIG. 4 is a diagram illustrating a configuration example of a protocol stack for a user plane according to an embodiment.

FIG. 5 is a diagram illustrating a configuration example of a protocol stack for a control plane according to an embodiment.

FIG. 6 is a diagram illustrating a configuration example of a mobile communication system 1 according to a first embodiment.

FIG. 7 is a sequence chart illustrating an operation example according to the first embodiment.

FIG. 8 is a flowchart illustrating an operation example according to a second embodiment.

### DESCRIPTION OF EMBODIMENTS

The present disclosure provides a communication control method capable of appropriately recording a log for a predetermined processing operation and transmitting the log to a base station.

A mobile communication system according to an embodiment is described with reference to the drawings. In the description of the drawings, the same or similar parts are denoted by the same or similar reference signs.

Mobile Communication System

First, a configuration of a mobile communication system in an embodiment is described. Although the mobile communication system according to the embodiment is a 5G system of the 3GPP, LTE may be at least partially applied to the mobile communication system. Future mobile communication systems such as the 6G may be applied to the mobile communication system.

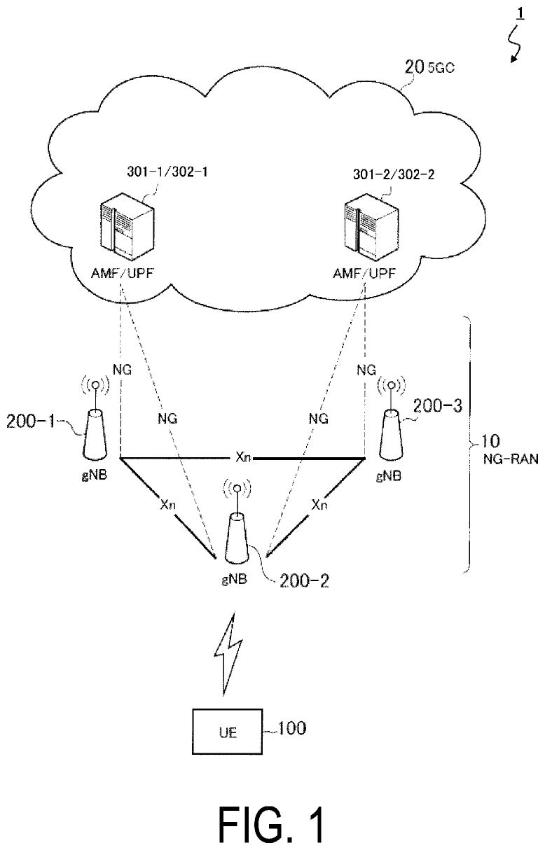

FIG. 1 is a diagram illustrating a configuration example of a mobile communication system 1 according to an embodiment.

As illustrated in FIG. 1, the mobile communication system 1 includes a User Equipment (UE) 100, a 5G radio access network (Next Generation Radio Access Network (NG-RAN)) 10, and a 5G Core Network (5GC) 20.

The UE 100 is a mobile apparatus. The UE 100 may be any apparatus as long as utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), or a flying object or an apparatus provided on a flying object (Aerial UE).

The NG-RAN 10 includes base stations (referred to as “gNBs” in the 5G system) 200. The gNBs 200 may also be referred to as NG-RAN nodes. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB 200 may be connected to an Evolved Packet Core (EPC) which is a core network of LTE, or a base station of LTE may be connected to the 5GC 20. The base station of LTE and the gNB 200 may be connected to each other via the inter-base station interface.

The 5GC 20 includes an Access and Mobility Management Function (AMF) 301 (301-1,301-2) and a User Plane Function (UPF) 302 (302-1, 302-2). The AMF 301 performs various types of mobility controls and the like for the UE 100. The AMF 301 communicates with the UE 100 by using Non-Access Stratum (NAS) signaling, and thereby manages information of an area in which the UE 100 exists. The UPF 302 controls data transfer. The AMF 301 and the UPF 302 are connected to the gNB 200 via an NG interface which is an interface between the base station and the core network. The AMF 301 and the UPF 302 are examples of core network apparatuses connected to the 5GC (core network) 20.

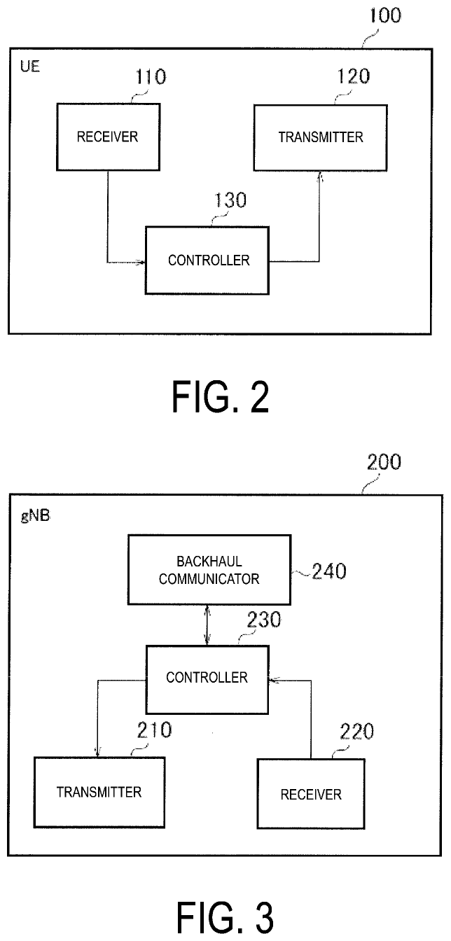

FIG. 2 is a diagram illustrating a configuration example of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts (down-converts) a radio signal received through the antenna into a baseband signal (a received signal) and outputs the resulting signal to the controller 130.

The transmitter 120 performs various types of transmission under control of the controller 130. The transmitter 120 includes an antenna and a transmission device. The transmission device converts (up-converts) a baseband signal output by the controller 130 (a transmission signal) into a radio signal and transmits the resulting signal through the antenna.

The controller 130 performs various types of control in the UE 100. The controller 130, the controller 130 includes at least one processor and at least one memory electrically connected to the processor. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 130 may perform various types of operation and various types of processing performed by the UE 100 in each embodiment described below.

FIG. 3 is a diagram illustrating a configuration example of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts (up-converts) a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts (down-converts) a radio signal received through the antenna into a baseband signal (a received signal) and outputs the resulting signal to the controller 230.

The controller 230 performs various types of controls for the gNB 200. The controller 230 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The controller 230 may perform various types of operation and various types of processing performed by the gNB 200 in each embodiment described below.

The backhaul communicator 240 is connected to a neighboring base station via the inter-base station interface. The backhaul communicator 240 is connected to the AMF 301 and/or the UPF 302 via the interface between the base station and the core network. Note that the gNB 200 may include a Central Unit (CU) and a Distributed Unit (DU), and both units may be connected to each other via an F1 interface.

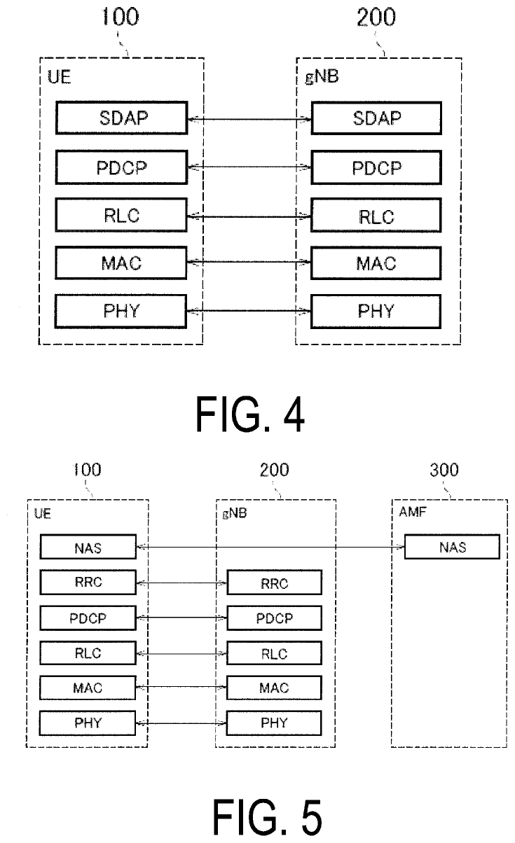

FIG. 4 is a diagram illustrating a configuration example of a protocol stack for a radio interface of a user plane according to an embodiment.

As illustrated in FIG. 4, a radio interface protocol of the user plane handling data includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs priority control of data, retransmission processing using a hybrid ARQ (HARQ), a random access procedure, and the like. Data and control information are transmitted between the MAC layer of the UE 100 and the MAC layer of the gNB 200 via a transport channel. The MAC layer of the gNB 200 includes a scheduler. The scheduler determines uplink and downlink transport formats (transport block sizes, modulation and coding schemes (MCSs)), and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption. Data and control information are transmitted between the PDCP layer of the UE 100 and the PDCP layer of the gNB 200 via a radio bearer.

The SDAP layer maps a QoS flow that is a unit in which the core network performs QoS control onto a radio bearer that is a unit in which the access stratum (AS) performs QoS control. Note that, when the RAN is connected to the EPC, the SDAP need not be provided.

FIG. 5 is a diagram illustrating a configuration example of a protocol stack for a radio interface of a control plane according to an embodiment.

As illustrated in FIG. 5, the protocol stack for the radio interface of the control plane handling signaling (control signal) includes a Radio Resource Control (RRC) layer and a NAS layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the RRC connection is suspended, the UE 100 is in an RRC inactive state.

The Non-Access Stratum (NAS) layer which is positioned upper than the RRC layer performs session management, mobility management, and the like. NAS signaling is transmitted between the NAS layer of the UE 100 and the NAS layer of the AMF 301.

Note that the UE 100 includes an application layer other than the protocol of the radio interface.

### First Embodiment

A first embodiment will be described.

As described above, the network slicing makes it possible to provide various services that meet the user's requirements. Hereinafter, the network slicing may be referred to as the “slice”. In network slicing, a part supported by the NG-RAN 10 may be referred to as RAN slicing. Even when network slicing and RAN slicing are not distinguished from each other, they may be simply referred to as “slice” hereinafter.

Note that a slice indicates a logically divided core network and/or radio access network. An identifier for identifying a slice includes Network Slice Selection Assistance Information (NSSAI), or Single-NSSAI (S-NSSAI).

A slice group is a group including one or more slices, and an identifier (ID) is assigned to the group. The slice group may be created in a core network (e.g., AMF 301) or in a radio access network (e.g., gNB 200). The UE 100 may be notified of the created slice group.

In 3GPP, slice-specific cell reselection is under study. In the slice-specific cell reselection, a frequency is mapped to (or associated with) each slice, and a priority (absolute priority) is configured for each frequency. Performing cell reselection using the configuration is referred to as slice-specific cell reselection. The slice-specific cell reselection enables, for example, a frequency resource to be provided for each slice (or each slice group), and a situation to be suppressed in which the frequency resource overlaps between slices. Controlling the frequency priority for the cell which the UE 100 camps on (or reselects) for each slice (or each slice group) enables the UE 100 to exist (distribute/disperse) at appropriate frequency for each slice which the UE 100 desires to access. The UE 100 is also enabled to camp on (exist) at a frequency (or in a cell) different from a frequency of a UE that does not desire to access a slice (e.g., a legacy UE).

For the slice-specific cell reselection, 3GPP agreed that:
1) a prioritized frequency mapped to each slice is provided to the UE 100,
2) a “slice” may mean a “slice group”,
3) the prioritized frequency mapped to each slice is a part of “Slice info”, and the like.

In 3GPP, slice-specific random access channel(s) (RACH(s)) are under study. For the slice-specific random access channel (hereinafter, also referred to as “slice-specific RACH”), a separated random access occasion (RACH Occasion (RO) and/or a separated preamble for each slice or each slice group are used. The random access procedure performed using RACH resources thus separated for each slice or each slice group is referred to as a slice-specific RACH. The slice-specific RACH enables a situation to be suppressed in which the resource overlaps, for example, between slices, between slice groups, or between access using a slice and access not using a slice. Avoiding the resource from overlapping enables suppressing interference of RACHs transmitted by a plurality of UE 100. Access to a certain slice or slice group can be controlled to be prioritized (by allocating a resource in which interference is less likely to occur).

Furthermore, in 3GPP, “intended slice” is also under study. However, 3GPP has not reached an agreement on the definition of concrete matters such as “intended slice”. In the first embodiment, a slice that is likely to be used, a candidate slice, a desired slice, a slice with which communication is desired, a requested slice, an allowed slice, or an intended slice is referred to as an “intended slice”. For example, the UE 100 can access a cell supporting the “intended slice” to receive a desired service from the cell.

On the other hand, in the wireless communication field, there have conventionally been Self Organizing/Optimizing Network (SON) and Minimization of Drive Tests (MDT).

The SON is a technique for autonomously organizing or optimizing the network. Specifically, the SON is a technique for achieving continuous optimization in response to a dynamic change of a network, optimization of parameters in troubleshooting, optimization of coverage and capacity, and the like. Using such functions of the SON to automate processes such as planning, configuration, and optimization of the network makes it possible to reduce the work of the operator (communication carrier) and reduce the operation cost.

The MDT is also a technique for supporting collection of UE 100-specific measurement values. The MDT allows the measurement date collected in a drive test by an electric measuring vehicle to be implemented by using the UE 100, so that the measurement and the collection can be automated, and man-hours and costs can be reduced.

In the first embodiment, an example is described in which the UE 100 records information acquired by performing the slice-specific RACH (attempt) as a log in the memory, as the functions of the SON and the MDT.

To be specific, first, the user equipment (for example, UE 100) performs a slice-specific random access channel which is a random access procedure using a resource separated for each slice or each slice group. Second, the user equipment records first log information acquired when the slice-specific random access channel is performed in the memory. Third, the user equipment transmits the first log information to the base station (e.g., gNB 200).

This allows, for example, the UE 100 to appropriately record the log related to the slice-specific RACH and transmit the log to the gNB 200.

### Operation Example According to First Embodiment

An operation example in the first embodiment will be described.

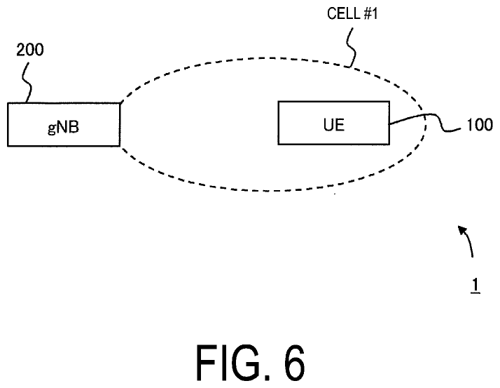

FIG. 6 is a diagram illustrating a configuration example of the mobile communication system 1 according to the first embodiment. As illustrated in FIG. 6, the operation example in the first embodiment is described using an example in which the UE 100 performs the slice-specific RACH to connect to a cell in the gNB 200. Then, in the example, the UE 100 records the first log information acquired by performing the slice-specific RACH and transmits the first log information to the gNB 200.

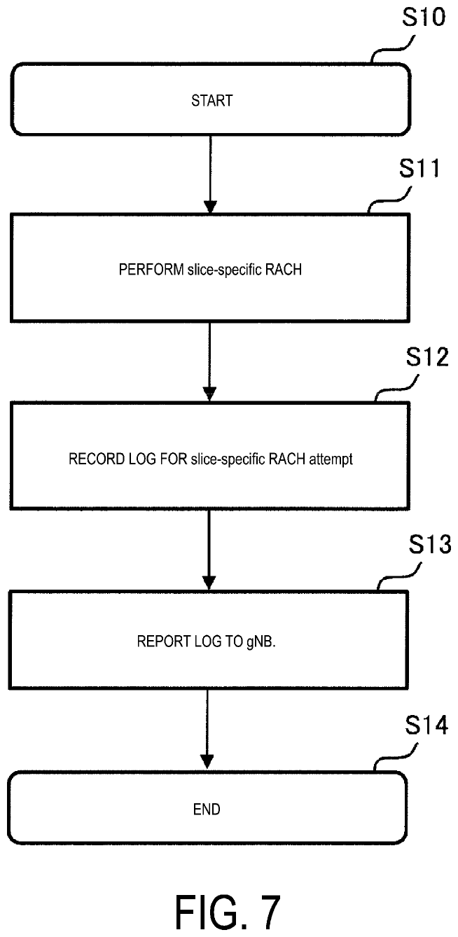

FIG. 7 is a sequence chart illustrating an operation example according to the first embodiment.

As illustrated in FIG. 7, in step S10, the UE 100 starts processing.

In step S11, the UE 100 performs slice-specific RACH. For example, the UE 100 acquires a parameter for the slice-specific RACH from the gNB 200 through System Information Block (SIB: system information) or dedicated signaling, and performs a random access procedure using the parameter, thereby performing the slice-specific RACH.

In step S12, the UE 100 records first log information in a memory with respect to the performed slice-specific RACH.

The first log information may include not only the slice-specific RACH but also log information that can be acquired by performing a normal random access procedure. Examples of such log information include the following.

First, at least one selected from the group consisting of the number of random access preambles transmitted from the UE 100, the total number of consecutive random access preambles transmitted from the UE 100, and contention detection may be included. Such information is also information transmitted from the UE 100 to the gNB 200 as information included in a connection establishment failure report (ConnEstFailReport).

Second, at least one selected from the group consisting of a cell ID of a cell in which the slice-specific RACH is performed, a random access purpose, and the number of RACH occasions may be included. Such information is also information transmitted from the UE 100 to the gNB 200 as information included in a random access report (RA-Report) or a radio link failure report (RLF-Report).

In the first embodiment, a log specific to the slice-specific RACH is recorded as the first log information in the memory. In other words, when performing the slice-specific RACH (RACH attempt), the UE 100 records any one of the following pieces of information as the first log information.
(A1) A slice identifier associated with a physical random access channel (Physical RACH (PRACH)) resource on which the RACH attempt is performed.
(A2) Resource information or resource ID for the RO on which the RACH attempt is performed.
(A3) Resource information or resource ID for a preamble on which the RACH attempt is performed.
(A4) Information indicating a priority RACH purpose to a certain slice. The UE 100 may further record an identifier of a slice or slice group to which the priority RACH (priority access) is performed.

The above (A1) and (A4) include, for example, information relating to the slice, and can be said to be a log specific to the slice-specific RACH. For example, in the slice-specific RACH, since a RACH resource separated for each slice group are used, which RACH resource is used can be recorded owing to (A2) and (A3).

In step S13, the UE 100 transmits the first log information recorded in the memory to the gNB 200. For example, the UE 100 may transmit a UE information response message including the first log information to the gNB 200. In this case, the UE 100 transmits the UE information response message as a response message to a UE information request message received from the gNB 200. Note that the UE 100 may transmit the above (A4) by transmitting the UE information response message in which “Slice-specific RACH attempt” is set in an IE “raPurpose” indicating the random access purpose.

In step S14, the UE 100 ends a series of processing operations.

### Variation of First Embodiment

The first embodiment describes the example in which the information included in the connection establishment failure report, the random access report, or the radio link failure report is recorded as a log, as the log information that can be acquired by performing the normal RACH. As a variation of the first embodiment, at least one selected from the group consisting of a time stamp, position information (latitude, longitude, altitude, and the like), and a radio condition (Reference Signal Received Power (RSRP), Reference Signal Received Quality (RSRQ), Signal to Interference plus Noise Ratio (SINR), and the like) may be recorded as the first log information and transmitted to the gNB 200, as the log information that can be acquired by performing the normal RACH.

### Second Embodiment

A second embodiment is described.

As the functions of the SON and the MDT, the cell ID of the cell visited by the UE 100 or the like may be reported to the gNB 200 as a mobility history report (MobilityHistoryReport). However, specifications of reporting a result of cell reselection in the UE 100 to the gNB 200 has not been drafted.

On the other hand, when the above-described slice-specific cell reselection is introduced, whether the UE 100 can reselect a cell supporting a desired slice (“intended slice”) is expected to be one piece of information for optimizing the network. For example, the operator can newly deploy a cell that supports an Ultra-Reliable and Low Latency Communications (URLLC) slice in an area where many UEs 100 exist desiring the URLLC slice as the desired slice.

Therefore, the second embodiment describes an example in which a result of performing the slice-specific cell reselection is recorded as a log. To be specific, first, the user equipment (e.g., UE 100) performs slice-specific cell reselection using a prioritized frequency mapped for each slice. Second, the user equipment records second log information acquired when the slice-specific cell reselection is performed in the memory. Third, the user equipment transmits the second log information to the base station (e.g., gNB 200).

This makes it possible to, for example, appropriately record the log in the slice-specific cell reselection. This also makes it possible to provide the network optimization.

### Operation Example According to Second Embodiment

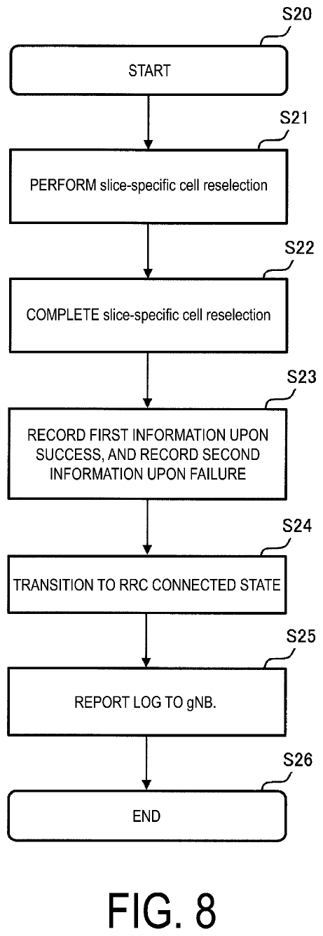

FIG. 8 is a flowchart illustrating an operation example according to the second embodiment.

As illustrated in FIG. 8, in step S20, the UE 100 starts processing.

In step S21, the UE 100 performs slice-specific cell reselection. For example, the UE 100 acquires a parameter for the slice-specific cell reselection from the gNB 200 through the SIB or dedicated signaling, and performs cell reselection using the parameter, thereby performing the slice-specific cell reselection.

In step S22, the UE 100 completes the slice-specific cell reselection. Whether the slice-specific cell reselection is completed may be determined based on whether a predetermined completion condition is satisfied. The predetermined completion condition is, for example, any one of 1) the prioritized frequency (or cell) associated with the slice is reselected, 2) the highest priority frequency (or cell) is reselected, and 3) the reselected cell (or frequency) transmits the slice-specific RACH parameter corresponding to the slice identifier indicating the “intended slice”. The UE 100 may determine a condition other than such predetermined completion conditions as the completion condition.

In step S23, when the UE 100 succeeds in the slice-specific cell reselection, the UE 100 records the first information as the second log information in the memory. In step S23, when the UE 100 fails in the slice-specific cell reselection, the UE 100 records the second information as the second log information in the memory. Whether the slice-specific cell reselection is succeeded or failed may be determined based on whether a completion condition is satisfied, for example. Note that when the UE 100 fails in the slice-specific cell reselection, the UE 100 performs the normal cell reselection.

The first information may be, for example, any one of the following.
(B1) An identifier of a desired slice (intended slice). For example, this is the S-NSSAI of the “intended slice” or the like.
(B2) Information indicating that the slice-specific cell reselection is completed.
(B3) Information indicating existing in the cell supporting the slice (“intended slice”).
(B4) Information indicating existing in the cell supporting the priority access for the slice (“intended slice”). For example, when the UE 100 receives the parameter for the slice-specific RACH in the cell in which the UE 100 exists, existing in the cell supporting the priority access for the slice can be determined.
(B5) Information indicating which cell (or frequency) is reselected in order of the priority specified by the slice-specific cell reselection parameter.
(B6) Information of the reselected cell (or frequency). Such information may be represented by a cell ID or an Absolute radio-frequency channel number (ARFCN).

On the other hand, the second information may be, for example, any one of the following.
(C1) An identifier of a desired slice (intended slice). For example, an identifier of a desired slice when the slice-specific cell reselection is failed for a cell supporting the desired slice.
(C2) Information indicating that the slice-specific cell reselection is failed.
(C3) Information indicating existing in a cell not (or probably not) support the slice (“intended slice”).
(C4) Information indicating existing in a cell not supporting the priority access for the slice (“intended slice”). For example, when the UE 100 does not receive the parameter for the slice-specific RACH in the cell in which the UE 100 exists, existing in the cell not supporting the priority access for the slice can be determined.
(C5) Information of the reselected cell (or frequency).

Note that the UE 100 may record at least one selected from the group consisting of a time stamp, position information (latitude, longitude, altitude, and the like), and a radio condition (RSRP, RSRQ, SINR, and the like) as the second log information.

In step S24, the UE 100 transitions to the RRC connected state. After transitioning to the RRC connected state, the UE 100 may notify the gNB 200 of the information indicating that the log related to the slice-specific cell reselection is recorded. The notification may be performed by the UE 100 transmitting an RRC setup complete message or an RRC release complete message including “Slice-specific cell reselection log available”.

In step S25, the UE 100 transmits the log recorded in the memory (the second log information) to the gNB 200. For example, the UE 100 may include the log in the UE information response message that is a response message to the UE information request message received from the gNB 200, and transmit the UE information response message.

In step S26, the UE 100 ends a series of processing operations.

### Other Embodiments

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1: Mobile communication system
10: 5GC
100: UE
110: Wireless communicator
130: Controller
200: gNB
210: Wireless communicator
220: Network communicator
230: Controller
301: AMF
302: UPF

1. A communication control method used in a mobile communication system comprising a user equipment and a network node, and being capable of performing wireless communication between the user equipment and the network node, the communication control method comprising steps of:
performing, by the user equipment, an operation relating to a slice group of network slicing;
recording, by the user equipment, log information in a memory during the operation relating to the slice group; and
transmitting, by the user equipment, the log information to the network node.

2. The communication control method according to claim 1, wherein
the performing the operation relating to a slice group includes performing, by a user equipment, a random access procedure using a resource associated with a slice group;
the recording includes recording, by the user equipment, first log information in a memory, the first log information being acquired when the random access procedure is performed; and
the transmitting includes transmitting, by the user equipment, the first log information to a network node.

3. The communication control method according to claim 2, wherein the first log information is at least one selected from the group consisting of an identifier of the slice group associated with the resource, information relating to a random access occasion, information relating to a preamble, and information indicating a priority random access purpose to a slice.

4. The communication control method according to claim 2, wherein the user equipment receives a parameter for the slice-specific RACH from the network node before the operation relating to a slice group.

5. The communication control method according to claim 2, wherein the first log information includes one of a number of random access preambles transmitted from the user equipment, a total number of consecutive random access preambles transmitted from the user equipment, and contention detection.

6. The communication control method according to claim 2, wherein the first log information includes one of a cell ID of a cell in which the slice-specific RACH is performed, a random access purpose, and the number of RACH occasions.

7. The communication control method according to claim 2, wherein the first log information includes one of a slice identifier associated with a physical random access channel resource on which the RACH attempt is performed, resource information or resource ID for the RO on which the RACH attempt is performed, resource information or resource ID for a preamble on which the RACH attempt is performed, information indicating a priority RACH purpose, and an identifier of a slice or slice group to which the priority RACH is performed.

8. The communication control method according to claim 2, wherein the first log information includes one of a time stamp, position information, and a radio condition.

9. The communication control method according to claim 1, wherein
the performing the operation relating to a slice group includes performing, by a user equipment, slice-specific cell reselection using a prioritized frequency mapped per slice group;
the recording includes recording, by the user equipment, second log information in a memory, the second log information being acquired when the slice-specific cell reselection is performed; and
the transmitting includes transmitting, by the user equipment, the second log information to a network node.

10. The communication control method according to claim 9, wherein the second log information is at least one selected from the group consisting of an identifier of a desired slice group, information indicating that the slice-specific cell reselection has been completed or has failed, information indicating existing in a cell supporting or not supporting the identifier of the desired slice group, information indicating existing in a cell supporting or not supporting priority access to the desired slice group, and information of a reselected cell or a frequency.

11. The communication control method according to claim 9, wherein the second log information includes one of information indicating which cell or frequency is reselected in order of the priority specified by the slice-specific cell reselection parameter, information for reselected cell or frequency, a cell ID for reselected cell or frequency, and an absolute radio-frequency channel number (ARFCN) for reselected cell or frequency.

12. The communication control method according to claim 9, wherein the second log information includes one of an identifier of a desired slice or intended slice, information indicating that the slice-specific cell reselection is failed, information indicating existing in a cell not support the slice, information indicating existing in a cell not supporting priority access for the slice, and information of the reselected cell or frequency.

13. The communication control method according to claim 9, wherein the second log information includes one of a time stamp, position information, and a radio condition.

14. A mobile communication system comprising:
a user equipment; and
a network node performing wireless communication with the user equipment; wherein
the user equipment comprising transceiver circuitry and processing circuitry operatively associated with the transceiver circuitry and configured to execute processes of:
performing, by the user equipment, an operation relating to a slice group of network slicing;
recording, by the user equipment, log information in a memory during the operation relating to the slice group; and
transmitting, by the user equipment, the log information to the network node.

15. The mobile communication system according to claim 14, wherein
the performing the operation relating to a slice group includes performing, by a user equipment, a random access procedure using a resource associated with a slice group;
the recording includes recording, by the user equipment, first log information in a memory, the first log information being acquired when the random access procedure is performed; and
the transmitting includes transmitting, by the user equipment, the first log information to a network node.

16. The mobile communication system according to claim 15, wherein the first log information includes one of an identifier of the slice group associated with the resource, information relating to a random access occasion, information relating to a preamble, and information indicating a priority random access purpose to a slice.

17. The mobile communication system according to claim 15, wherein the user equipment receives parameter for the slice-specific RACH from the network node before the operation relating to a slice group

18. A user equipment comprising:
transceiver circuitry; and
processing circuitry operatively associated with the transceiver circuitry and configured to execute processes of:
performing, by the user equipment, an operation relating to a slice group of network slicing;
recording, by the user equipment, log information in a memory during the operation relating to the slice group; and
transmitting, by the user equipment, the log information to the network node.
